(19) United States
(12) Patent Application Publication
(10) Pub. No.: US 2015/0180845 A1
(43) Pub. Date: Jun. 25, 2015

(54) ELECTRONIC MAIL SYSTEM AND METHODS

(71) Applicant: Robert Uomini, Kensington, CA (US)

(72) Inventor: Robert Uomini, Kensington, CA (US)

(21) Appl. No.: 14/135,127

(22) Filed: Dec. 19, 2013

(51) Int. Cl. H04L 29/06; H04L 12/58

(52) U.S. Cl. CPC H04L 63/08; H04L 51/04; H04L 63/083; H04L 51/08

(57) ABSTRACT

Disclosed is an envelope content splitting (ECS) technology, including systems and methods, which can enable secure sending, retrieving and updating of emails. In addition, users of the ECS technology can register with a content server for obtaining a password that can be used to provide the user with access to the content server, including for storing, retrieving and updating content stored on the content server.

### FIELD

The subject matter described herein relates to embodiments of envelope content splitting (ECS) technology, including systems and methods enabling secure sending, retrieving and updating of emails.

### BACKGROUND

Electronic mail, or email, can be described as a method of exchanging digital messages from a message sender to a message recipient. In general, an email message includes at least a message envelope and a message body. The message envelope can include a collection of information provided by the outgoing mail server that can be used to direct the electronic mail to the message recipient, such as the email address of the sender and the email address of the message recipient, as well as a variety of fields that can provide information about the email message, such as the date the email was sent and the email address of the sender. The message body can include message content prepared by the message sender. Furthermore, the email message may include one or more attachments.

### SUMMARY

Disclosed herein are implementations of envelope content splitting (ECS) technology, including systems and methods enabling secure sending, retrieving and updating of emails. An embodiment of the ECS technology includes a non-transitory computer program, which, when executed by at least one data processor, causes the at least one data processor to perform operations. In addition, the operations performed by the at least one data processor may include sending an electronic message from a mail client with the electronic message including message content. Additionally, the operations performed by the at least one data processor may include facilitating determination of a first user's permission for content server access, sending the message content to the content server for storage, and receiving a pointer at the mail client with the pointer intended to effect retrieval of the message content by a second user. Furthermore, the operations performed by the at least one data processor may include inserting the pointer into a header of the electronic message at the mail client and sending the electronic message with the header, but excluding the message content, to the second user.

An embodiment of a method may include sending an electronic message from a mail client, with the electronic message including message content. In addition, the method can include facilitating determination of a first user's permission for content server access, sending the message content to the content server for storage, and receiving a pointer at the mail client with the pointer configured to effect retrieval of the message content by a second user. Additionally, the method can include inserting the pointer into a header of the electronic message at the mail client and sending the electronic message with the header to the second user.

The details of one or more variations of the subject matter described herein are set forth in the accompanying drawings and description below. Other features and advantages of the subject matter described herein will be apparent from the description and drawings, and from the claims.

### BRIEF DESCRIPTION OF THE FIGURES

These and other aspects will now be described in detail with reference to the following drawings.

FIG. 1 illustrates an embodiment of a system using the presently disclosed ECS technology and showing at least one communication pathway between a sending mail client and a receiving mail client.

FIG. 1A illustrates an embodiment of a user's email inbox that provides visual indication as to which emails are ECS email, non-ECS email, possible spoofed e-mail or non-ECS email from ECS registrants.

FIG. 2 illustrates a process flow diagram illustrating an embodiment of a method including at least composing and sending a message using the present ECS technology.

FIG. 3 illustrates a flow diagram showing an embodiment of a process for a sender to retrieve and update the message body of an ECS email that has been sent.

FIG. 4 illustrates a flow diagram including an embodiment of a process for updating an attachment to an ECS message.

FIG. 5 illustrates a flow diagram showing an embodiment of a process for allowing an ECS email message recipient to view the message content.

FIG. 6 illustrates a flow diagram showing an embodiment of a process for allowing an ECS email message recipient to view attachment content.

Like reference symbols in the various drawings indicate like elements.

### DETAILED DESCRIPTION

The present disclosure describes embodiments of envelope content splitting (ECS) technology, including systems and methods enabling separate entities to host their own (“private”) ECS content servers, rather than using a third party's content server. In addition, the ECS technology of the present disclosure can enable owners of private content servers to provide authentication of their users without requiring users to reveal their personal information, such as email addresses, to a third party content server.

Additionally, the present ECS technology does not require users to register unique e-mail addresses with each content server. As such, a user can use an email address that the user has already been associated with and has been using. This can simplify the user's management of email addresses by limiting the number of email addresses the user is required to have while still being able to send and receive secure emails.

In some embodiments of the present ECS technology, the user can configure a mail client to a content server for enabling secure communications using the ECS technology. Configuration of the mail client to a content server, including a public content server, can involve content server registration of an email address by the user and the user obtaining a content server password as a result of registering the email address.

In some embodiments of the present ECS technology, the registration system can send an email containing a hyperlink to a page containing the assigned password resulting from a registration step initiated by the user or initiated automatically by the mail client. The password can then be used by the user when communicating with the content server, such as either sending or receiving emails using the ECS technology. For example, the user can provide the assigned password to the content server when attempting to retrieve or change email message content of an email stored on the content server.

A content server can determine whether a user has permission to access information stored on the content server by comparing the password provided by the user against a content server database. For example, the content server database may contain a list of passwords identifying registered users who can access the content server, such as for storing and retrieving email content.

In some embodiments of the present ECS technology, a recipient of an email sent using ECS technology can register with a content server that is storing information related to the received email, such as a message body or an attachment. For example, the recipient can provide a password to the content server, such as a password assigned to the recipient after registering with the content server, in order to allow the content server to determine whether the recipient has permission to access the content stored on the content server. Once the recipient has been given permission, the recipient can then retrieve information, such as the message body or attachment, stored on the content server.

In some embodiments of the present ECS technology, once a user has registered an email address with at least one content server, the user, if desired, can then decide which of the configured content servers to use for sending an ECS message. In addition to selecting a content server, the user can specify default settings for the email “send mode” of an email message, such as either standard email or ECS. For ECS messages, the user can also select whether the message is to be encrypted prior to being sent, whether the message content is to be included with the message and, if this latter condition is not present, how much time the user is given to read the message and an expiration time and date after which the message is deleted, regardless of whether it had been read. Encryption of the message can provide additional levels of security and privacy regarding at least the message content.

Additionally, a user can configure the user's mail client in order to at least identify ECS emails and ECS registrants (i.e., an email sender who registered with a content server having ECS technology) in order to protect against spoofers. For example, a user can configure a mail client such that the mail client can enable the user to visually identify which emails in the user's inbox are ECS messages or have been sent from an ECS registrant. In addition, the user can configure the mail client such that it screens non-ECS messages or messages sent from non-ECS registrants so that they do not appear in the user's inbox.

In addition, the user's credentials, such as the user's email address and one or more content server passwords can be stored by the user's mail client, which can be retrieved by the user at a later time. For example, the user can retrieve the user's credentials, such as a content server password registered to the user, for accessing information stored on one or more content servers. In addition, information retrieved by the user can be automatically used by the system for accessing information on one or more content servers.

In some embodiments of the present ECS technology, when preparing an ECS message to be sent, the user may select whether the actual message is to be included in the transmission or whether a canned or default message is included or even no message at all. The canned or default message can include information about the type of email being sent, such as that the email is being sent using ECS technology.

In addition, some embodiments of the present ECS technology can include a license check feature that allows a mail client to check whether the content server identified in the message envelope is licensed to use ECS technology. For example, whenever a user on an ECS-enabled mail client attempts to read an ECS message, the mail client may first check to see if the message resides on a public content server (i.e., a content server not privately hosted by a separate entity for use by its associated users, such as hosted by ChiaraMail©) or whether the message resides on a private server (i.e., a content server privately hosted by a separate entity for use by its associated users). The mail client may determine whether the message resides on a public or private content server by identifying and analyzing a field in the message header, such as the content server name field.

If the mail client determines that the message resides on a private content server, the mail client may query the public server to determine if the uniform resource locator (URL) of the content server resides in a license file database. For example, the license file database can include a list of private content servers that are licensed to provide content service. If the content server URL is found in the license file database, the message may be authorized to be delivered. However, if the content server URL is not found in the license file database, the message may not be authorized for delivery and an error message may be produced. Additionally, if the content server is not currently licensed, requests originating from the mail client may not be sent to the content server.

In some embodiments of the present ECS technology, whenever a read request is received by the content server (public or private), the content server checks to see if the corresponding content server file for the purported sender and content server pointer exists. As such, if the content server file in question does not exist, the email may not be authorized for delivery and an error message may be produced. In particular, this feature can prevent phishers who send mail from email addresses containing user-recognizable names, such as those of well-known financial institutions or other companies. In addition, in order to prevent senders from sending fraudulent ECS messages, the sender's content server password may be checked against that of the purported sender.

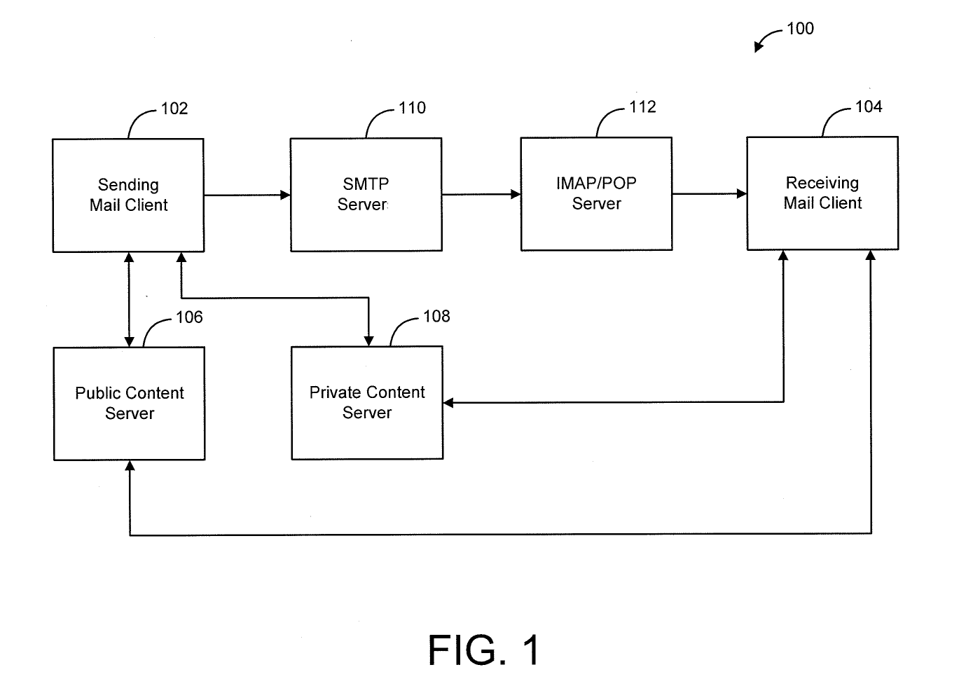

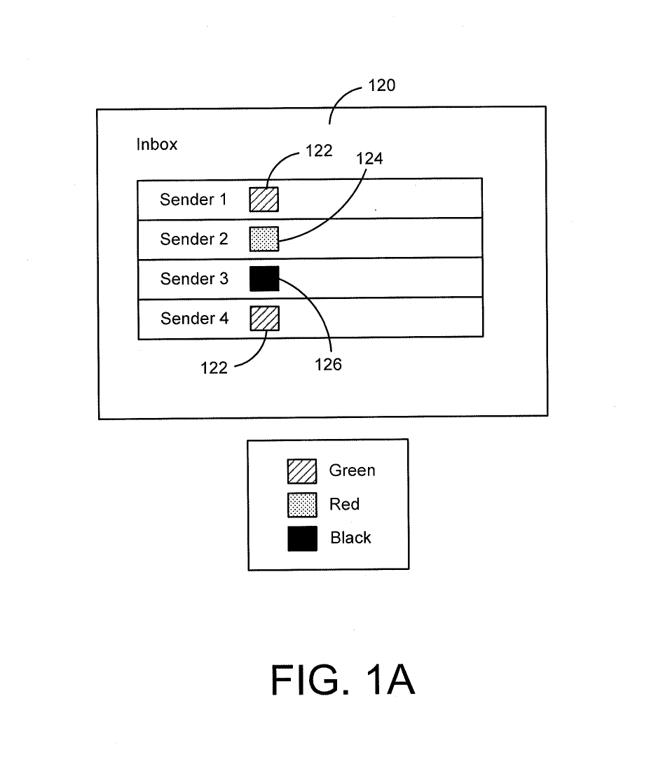

FIG. 1 illustrates an embodiment of a system 100 using the present ECS technology and showing at least one communication pathway between a sending mail client 102 and a receiving mail client 104. In addition, the system 100 in FIG. 1 may include a public content server 106 and a private content server 108, both of which can send and receive information between the sending mail client 102 and the receiving mail client 104. When sending and retrieving an email using the present ECS technology, the email content, such as the message body and any attachments, may be stored on a content server. Once stored on the content server, the email content can then be later accessed by the sender, such as for modifying the data stored on the content server, or can be accessed for retrieval by the recipient.

In some embodiments of the present ECS technology, the mail client can identify whether a message is an ECS message by looking into the envelope of the message in order to find at least one required ECS mail header field. In addition, to determine if a standard or ECS mail sender is registered to send ECS messages, the mail client may send a query to the content server.

In some embodiments of the present ECS technology, as shown in FIG. 1A, the mail client can identify an email as an ECS message, which can allow a user's inbox 120 to visually identify to the user that the email message is an ECS message, such as by showing the email message subject in green or with a green identifier 122. Additionally, the mail client can identify an email as a non-ECS message, which can allow the user's inbox 120 to visually identify to the user that the email message is not an ECS message, such as by showing the email message subject in black or with a black identifier 126. In addition, the mail client can indicate the occurrence of an error when attempting to read an ECS message, such as might occur as a result of a communications error or a spoofing attempt by the sender, which can allow the user's inbox 120 to visually identify to the user that the email message may not be displayed, such as by showing the email message subject in red or with a red identifier 124.

Although the visual identifiers of the email messages in the inbox are described as having various colors, the visual identifiers can be any one or more of a color, pattern, shape, icon, etc. that can allow a user to differentiate between email messages contained in the user's inbox. As such, the present ECS technology can assist in protecting users from spoofers by at least identifying unsecure messages, including non-ECS messages.

Another function of the public content server 106 may include functions for sending ECS messages. For example, the public content server 106 can provide a default means for sending ECS messages, such as when a user has not been granted permission to store ECS messages on a private content server.

As shown in FIG. 1, the system 100 can further include an SMTP server 110, and an IMAP/POP server 112, which can assist in delivering an email message from the sending mail client 102 to the receiving mail client 104. In addition, between the SMTP server 110 and IMAP/POP server 112, there may be one or more intermediate mail servers, or mail relay hosts.

Additionally, although the system 100 shown in FIG. 1 may have both a public content server 106 and a private content server 108, only one content server may be included in the system 100 (i.e., the public content server 106 or private content server 108) for sending an ECS message, while more than one content server may be present for reading ECS messages.

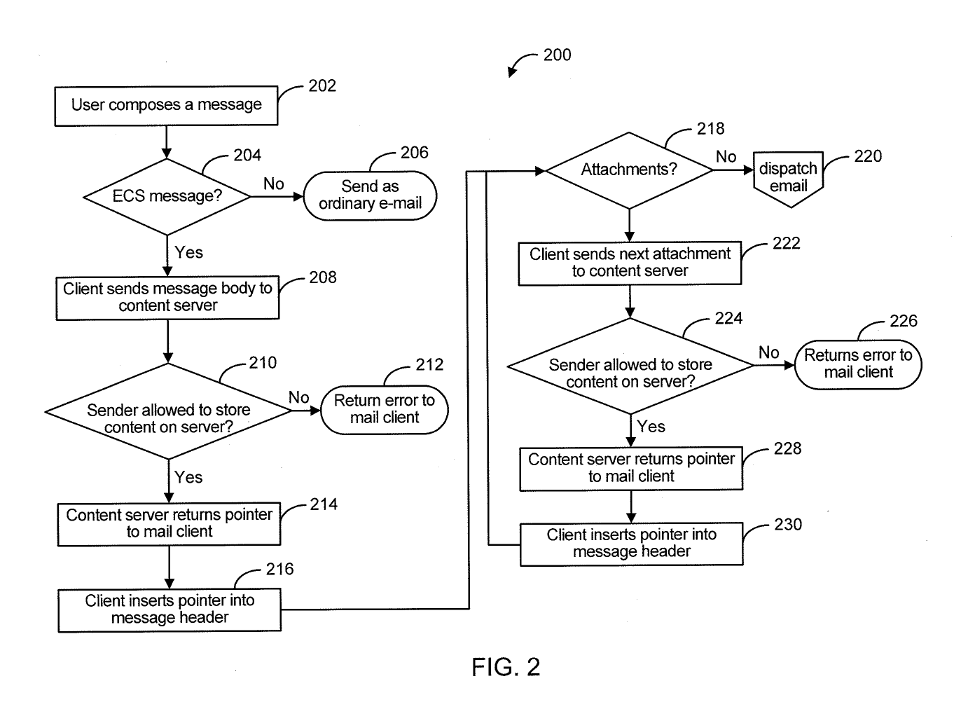

FIG. 2 illustrates an embodiment of a flow diagram 200 including at least composing and sending a message using the present ECS technology. As shown in FIG. 2, at 202, the user, or sender, can compose a message to be sent. In addition to composing the message, the sender can specify one or more recipients for receiving the message. For example, the sender can specify at least one recipient and can compose the message body using a mail client. Additionally, the sender can compose and/or add one or more attachments to the email message, as will be discussed further below.

Furthermore, at 204, the sender can choose whether to send the email as an ECS message or send the email as an ordinary email, as in 206. This can be provided to the sender in the form of an option that the user can select, such as by checking a box or selecting an icon that assists in directing the email message to be sent as either an ECS message or an ordinary email.

For example, at 208, if the sender selects to send the email message as an ECS email message, the mail client can then send the message body to the content server. In addition, the mail client can send at least some of the sender's credentials to the content server, such as the sender's email address and password registered to the content server. Additionally, the information provided by the mail client to the content server can be sent by way of a secure link in order to protect the contents of the information.

In some embodiments of the present ECS system, a user can chose to encrypt the message content, or message body, prior to sending an email. If the user chooses to encrypt the message content the content is encrypted and the encryption key may be inserted into the envelope of the email. For example, the mail client can create a random 256-bit advanced encryption standard (AES) encryption key to encrypt the message content and then insert the encryption key into the message envelope. In addition, the user can chose to encrypt message content when updating message content stored on the content server. When a recipient of the email requests to read the message content that was encrypted, the recipient's mail client decrypts the message (i.e., by using the encryption key that was inserted into the envelope) prior to displaying the message content to the recipient.

The content server can receive the information provided by the mail client and, at 210, determine whether the sender has permission to store content on the content server. Additionally, a permission error or communication error may be presented here, such as in the event the mail client is unable to properly communicate with the content server. In at least some embodiments of the present ECS technology, the sender can have permission to store content on the content server if the sender had previously completed the configuration and registration process with the content server and, thus, the content server recognizes the sender's credentials, such as either the sender's email or password, or both. For example, the content server can determine the sender has access by comparing the password provided by the sender's mail client with the content server's database of registered user passwords.

If the sender had not registered with the content server, so that the content server cannot validate the sender and cannot provide the sender with access to the content server or if there is a communications error, the content server can return an error message, at 212. The error message can be sent to the mail client, which can be relayed to the sender. If the sender receives the error message indicating that the content server will not allow the sender to save content, the sender can, for example, either register with the content server or send the message as ordinary email.

If the content server can validate the sender, the content server can further determine whether the sender has permission to store the message content on the content server. Once the content server has provided access to the sender and/or determined that the sender has permission to store message content, the content server can store the message content. If the sender does not have permission to store content on the content server, an error message can be returned. Additionally, for example, permission to store message content on the content server can be dependent upon an amount of storage space available to the user, which may be controlled independently via a server-side configuration step. As such, a user may receive an error message if the message content the user is attempting to store on the content server exceeds the user's storage allotment.

When the content server receives message content, the content server stores it in a way that it can be uniquely identified, such as within a file containing the e-mail addresses of all the recipients and whose name includes the sender's e-mail address and a content pointer. The content server can then return the pointer to the mail client, at 214. The pointer can be added to the mail message, for example, in the message header at 216. In addition, if the user is sending a self-destruct massage, the client can also include a message duration header field in the envelope. For example, the user can select whether the message self-destructs, such as permanently erases, after a defined period of time after the recipient has viewed the message, for example, approximately 1 to 10 seconds.

One or more attachments can also be sent by the sender to at least one recipient using the ECS technology. In addition, at least some of the processes and methods described above for creating ECS message content can be completed in a similar way for sending a message attachment. For example, at 218, the sender can decide whether to send at least one attachment. If the sender does not want to include an attachment, the sender can select to have the message sent to the one or more recipients, such as at 220. In addition, prior to sending the message, the mail client may either include the message content or not include the message content, depending on the user's choice when creating the ECS message. Additionally, the message content may be encrypted, as discussed above, if the user elects to have the message content encrypted when creating the ECS message.

The sender can select at least one attachment for sending to the at least one recipient. For example, the mail client can send the selected attachments to the content server for verification, at 222. The content server can verify whether the sender can store the contents of the attachments in the content server, such as at 224, or whether there are any permission or communication errors. If the sender does not have permission to store the attachment contents, the content server can return an error message, at 226.

In addition, the sender may not have enough storage available in the content server to store the email content, such as attachments or message content, and can thus be denied permission to store at least some of the email contents on the content server. This would also prevent the sender from sending the email as an ECS message. The sender may want to remove content uploaded onto the content server that is associated with the email that was unable to be sent with ECS technology. As such, the sender may send one or more requests to the content server to delete previous content associated with the unsent email. Some implementations of the ECS system can provide one or more messages sent by the content server to the sender that contain information regarding either the amount of available or unavailable storage space on the content server for the sender to store email content.

If the content server verifies the sender and determines that the sender has permission to store content on the content server, the content server can return the pointer, at 228, to the mail client that can include information related to the stored location of the attachment content. At 230, the mail client may insert the pointer into the header of the mail message. The above process for including an attachment can be repeated until the sender has completed preparing an ECS message including any number of attachments.

The email client can include a variety of information in the message prior to sending. For example, the mail client can include pointer information in the email message, such as information identifying the content server where the email content is stored. In addition, the email client can include information in the mail envelope identifying the port number that can be used to communicate with the content server.

The mail client can then dispatch the email to the at least one recipient. The email dispatched does not need to include any message content prepared by the sender and, instead, may include only the content server name, port number and pointer that can be used by the recipient, such as the recipient's mail client, to access and view the message content. Additionally, the email dispatched can also omit any attachment content and, instead, include a pointer that can be used by the recipient to access and view the attachment content. This can potentially reduce the amount of information sent across the Internet.

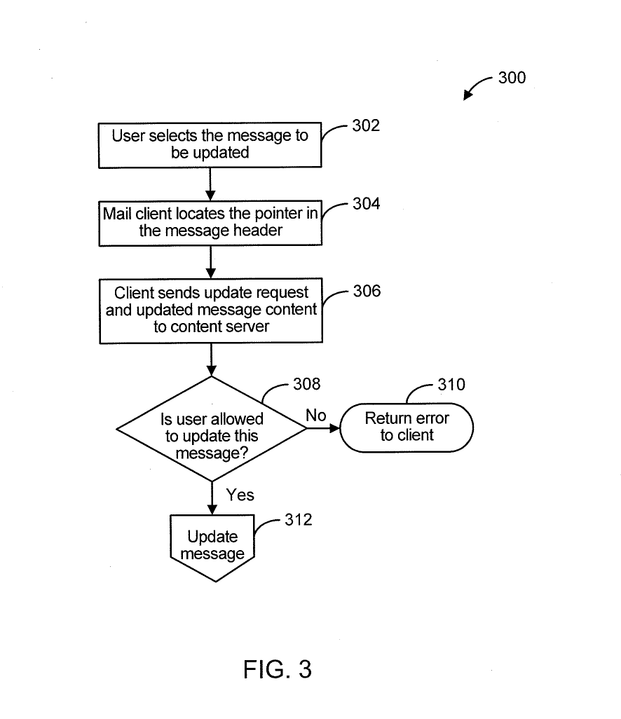

Some embodiments of the present disclosure allow the sender to retrieve and update a sent ECS email. FIG. 3 illustrates an embodiment of a flow diagram 300 showing a process for a sender to retrieve and update an ECS email that has been sent. For example, at 302, the sender, or user, can select the message that the sender would like to retrieve and update.

In addition, at 304, once the sender selects the sent ECS email message the sender wants to retrieve, the mail client can locate the message content, including any attachment content, on the content server. The mail client can use information included in the header of the email, such as the content server name, port and pointer, in order to locate the message content, including any attachment content, in the content server.

In addition, at 306, the mail client can send an update request, including an updated message body, to the content server. Then, at 308, the content server can verify whether the sender has permission to update the message stored on the content server or whether there are any communication errors between the mail client and the content server. If the sender does not have permission to update the message or if a communications error occurs during an update operation, the content server can return an error message, at 310. However, if the sender has permission to update the message, at 312, and no communications error occurs, the content server can store the updated message body.

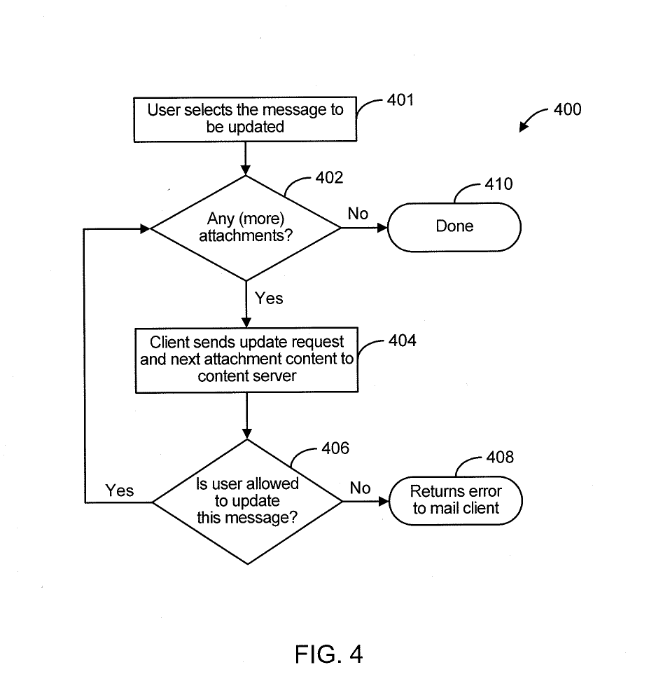

FIG. 4 illustrates an embodiment of a flow diagram 400 that includes at least part of a process for updating ECS message attachments. In particular, the sender can update the email by updating one or more attachments stored on the content server. For example, the sender can send a request to update a message stored on the content server at 401. At 402, the user can choose to update any stored attachment. The client server can then send the update request, at 404, to the content server. For example, with a single update request, all content associated with the email can be updated. Therefore, prior to the sender sending the update request (i.e., selecting an update button associated with the email), the sender can first complete all desired editing of any content associated with the email.

The content server can then verify whether the sender has permission to update the stored content on the content server, at 406. If the sender does not have permission to update attachment content, the content server can return an error message, at 408. However, if the sender has permission, the content server can update at least the attachment content. After updating the sent email, at 410, the updated email can be stored in the content server for retrieval by the one or more recipients. Additionally, the updated message may be marked as unread, so as to inform the recipient(s) of the changes to the message.

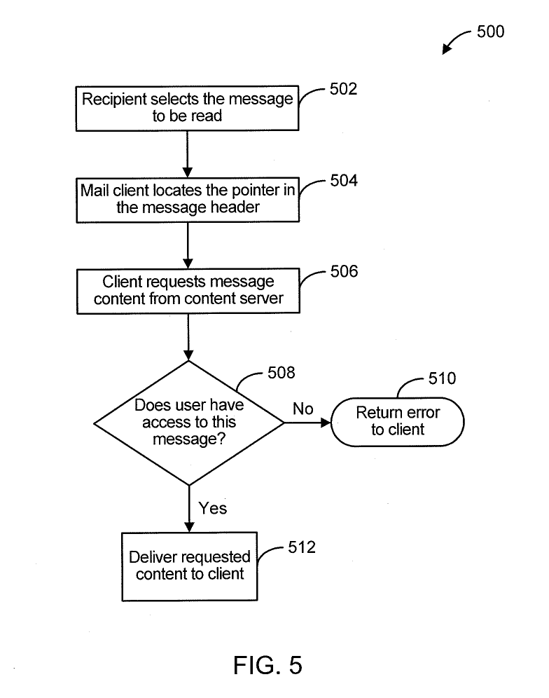

Upon receipt of the sender's ECS email in the recipient's inbox, the recipient can select the ECS email in order to view the contents of the email, including either the message content or attachment content. FIG. 5 illustrates an embodiment of a flow diagram 500 showing a process for allowing an ECS email message recipient to view the message body, or message content. For example, at 502, the recipient can select the message to be read. Then, at 504, the mail client of the recipient can locate the pointer to the message content contained in the message header, as designated by the sender, such as discussed above. In addition, at 506, the recipient's mail client can send a request to the content server to retrieve the message content. Again, the recipient mail client can use the information contained within the pointer located within the header of the email to send the request.

When the content server receives the request to retrieve the message content from the recipient mail client, the content server can initiate at least one verification or determination process for determining whether to deliver the message body to the requester, or recipient. For example, at 508, the content server can determine, first of all, whether the requester has permission to access the message content or whether there is a communication error between the mail client and content server. The recipient mail client can provide the content server with the recipient's credentials, such as the recipient's previously configured email address and password assigned by the content server. The content server may compare the recipient's credentials to a database of registered users as well as against the recipients listed in the message, in order to determine whether the recipient has permission to access the message content. Second, the content server may determine whether the requestor is a valid recipient. For example, by embedding a list of recipients in a file containing the message content at the time the message was received, the content server may perform this determination whenever a read request is received by the content server.

If the content server determines that the recipient does not have access, at 510, the content server can return an error and not the message content. However, if the content server determines that the recipient has access to receive the message content, the content server can validate the recipient and deliver the requested message content to the mail client, at 512. For example, the mail client can then display the message content in a viewing window for the recipient to view. Additionally, the message content can be inserted into the electronic message for viewing by the recipient.

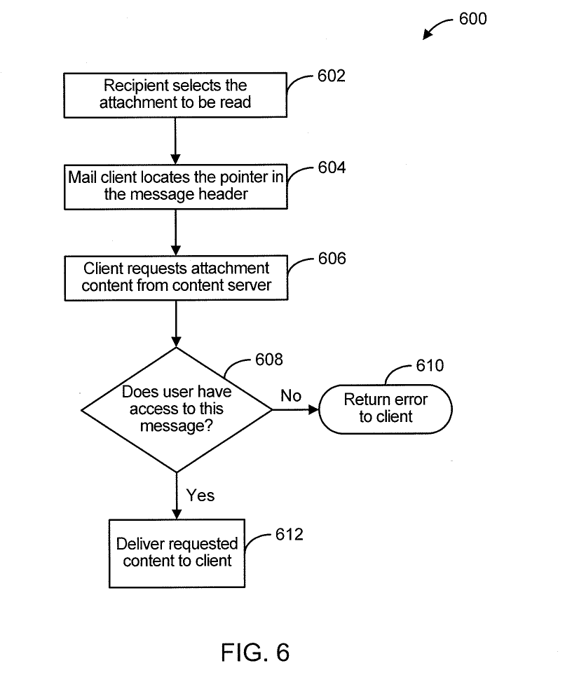

FIG. 6 illustrates a flow diagram 600 showing an exemplary process for allowing an ECS email message recipient to view attachment content. For example, at 602, the recipient can select the attachment to be read. Then, at, 604, the mail client of the recipient can locate the pointer included in the header of the email. In addition, at 606, the recipient's mail client can send a request to the content server to retrieve the attachment content, using the pointer provided in the header.

When the content server receives the request to retrieve the attachment content from the recipient mail client, the content server can initiate at least one verification process for determining whether to deliver the attachment content to the requester. For example, at 608, the content server can verify the recipient's credentials in order to determine whether the recipient has permission to retrieve the attachment content. In addition, the content server may determine whether the requestor is a valid recipient, such as discussed above.

If the content server determines that the recipient does not have permission, at 610, the content server can return an error message and not the message attachment. However, if the content server determines that the recipient has permission to receive the message attachment, the content server can validate the recipient and deliver the requested message attachment to the mail client, at 612. The mail client can then load the message content into the appropriate viewer for displaying the message attachment in a viewing window for the recipient to view. Additionally, the message attachment can be inserted into the electronic message for viewing by the recipient.

The ECS system and methods of the present disclosure provides an authentication scheme that ensures an e-mail purportedly sent by a given user, really is from that user, thus effectively preventing e-mail address spoofing from any source. In addition, since ECS messages may be sent through the mail network without their associated content, e-mail privacy is ensured, as the intermediate mail servers have access only to the message headers. Furthermore, because the message content resides in only one location (the content server), the sender retains complete control over the content, potentially indefinitely (for example, this control may be mediated by providing configuration parameters on the content server). Besides being able to change an e-mail message after sending it, the sender may also delete the message content, set message content to be visible for a specified period of time or even self-destruct at a pre-determined time and date. Furthermore, because only pointers, and not the actual message attachments, are sent to recipients, attachments of a theoretically unlimited size may be sent via ECS without severely impacting the recipients' inbox restrictions.

An embodiment of the ECS system can include a messaging or mail client, such as an email program, and a content server that can provide a variety of functions for sending ECS messages. For example, the mail client can be configured such that for each mail account supported by the mail client, one or more content servers are configured (i.e., a public content server and, possibly, one or more private content servers). Each content server configuration can include the following settings, any of which can be overridden at the time the message is composed: content server name, content server port, content server password (i.e., used to authenticate both ECS message senders and recipients), default message “send” mode (i.e., if selected, the message is sent using ECS; otherwise, the message is sent as ordinary mail), encryption (i.e., if selected, the message is encrypted prior to being sent to the content server and the encryption key may be stored in the message envelope), include content mode (i.e., if selected, the entire content is sent to the recipients, as well as to the content server, which enables mail clients that are not enabled for ECS to read ECS messages), self-destruct mode and time delay field (i.e., if selected, the message is deleted after the recipient has read it for the time period specified in the time delay field), and a designation whether the ECS configuration is to be used when sending ECS messages (the “default” configuration). Additionally, any of the options may be disabled, such as if the send mode is not set to ECS.

Furthermore, operation of the mail client can include sending an ECS message, which can include at least the user composing the message and optionally overriding the default settings. In addition, the mail client can attempt to establish a secure connection (i.e., using Hypertext Transfer Protocol Secure (HTTPS)) to the content server using the content server name and port number specified in the default content server configuration. If an error occurs, a suitable message can be displayed to the user and the processing may stop. Additionally, the mail client can retrieve the sender's email address and content server password contained in the default configuration and can format a “receive content” request for the content server, such as by using credentials, the list of email recipients and the email content. If the email content is to be sent encrypted, the mail client first encrypts the content and appends the encryption key in the header field (i.e., X-ChiaraMail-Content-Key2). The content server password and the optionally encrypted content can both be URL-encoded and Base64-encoded, for example, before the request is sent to the content server. If the self-destruct mode is selected, the mail client can fetch the display delay value from the default configuration and append it to the header field, which can then be added to the envelope. If the request is directed to a private content server (i.e., one whose URL is other than www.chiaramail.com), the client can check to see if the private server has an active license. If the private server does not have an active license, the transaction is not completed.

The “receive content” request can be sent to the content server, for example via HTTPS, and the content server can authenticate the sender's credentials. If authentication fails, an error is returned to the client. Otherwise, the content server can attempt to Base64-decode the content and store it in a file. If an error occurs, a suitable error code and message can be sent to the mail client; otherwise, a pointer to the content file may be returned to the mail client. If the content server returns an error, the mail client can display the error message to the user; otherwise, the mail client can append the pointer to the header field before adding the field to the envelope. If attachments are part of the message, one or more of the processes described above regarding the message content can be similarly completed for attaching at least one attachment to the message.

If an error occurs when sending the attachment to the content server, the mail client can send a “delete content” request to the content server for each message content that had been successfully processed by the content server for the present message. In this case, the content server can then delete the corresponding content file.

In addition, in order for a user, such as a message recipient, to read an ECS message, the user can first select the message to be read, via the mail client. The mail client can then attempt to establish a secure connection to the content server using the content server name and port number included in the message header. If an error occurs, a suitable message can be displayed to the user and processing may stop. The mail client may then format a “fetch content” request to the content server, which can specify the sender email address and the pointer included in the message header. For example, if the request is directed to a private content server (i.e., one whose URL is other than www.chiaramail.com) the mail client can check to see if the private server has an active license. If the private server does not have an active license, the transaction is not completed.

Additionally, the “fetch content” request can be sent to the content server via HTTPS and the content server can authenticate the sender's credentials. If authentication fails, such as either due to a password error or because the requestor is not a designated recipient of the message, an error may be returned to the mail client. Otherwise, the content server can attempt to fetch the content. If an error occurs, a suitable error code and message may be sent to the mail client; otherwise, the content may be returned to the mail client. The mail client Base64 can decode the message, if necessary, and the content can be displayed to the user. If an attachment is selected, at least some of what was described above for retrieving message content is completed for retrieving at least one attachment. The retrieved attachment is also loaded into an appropriate viewer for allowing the user to view the attachment content.

Furthermore, an ECS message can be updated by the user first selecting the message to be updated. If the message sender is the user, which can be determined by comparing the “from:” field in the message envelope with the user's email address, an “update content” selection or button can be displayed and enabled. The user can edit the message and then select the “update content” button. The mail client may then establish connection with the content server and the mail client may retrieve the sender's email address and content server password and format an “update content” request for the content server. The “update content” request may be sent to the content server via HTTPS and the content server may authenticate the sender's credentials. If authentication fails or if the sender is not the owner of the content file, an error is returned. Otherwise, the content server may attempt to Base64-decode the content, if any decryption is necessary, and replace the original content file with the edited content.

In addition, ECS messages of the present ECS system can be deleted. For example, the user can select a message to delete and if the message sender is the user, as determined by comparing the “from:” field in the message envelope with the user's email address, a “delete content” selection or button can be displayed and enabled. The user can then press the “delete content” button. The mail client may then attempt to establish a secure connection to the content server using the content server name and port number included in the message header. If an error occurs, a suitable message can be displayed and processing can stop. The mail client can retrieve the sender's email address and content server password contained in the default configuration and can format a “delete data” request for the content server (i.e., by using the credentials and the pointer to the content to be deleted). The content server can return a code indicating whether the “delete data” request was successful or not, which the mail client can use to inform the user.

Although a few specific embodiments have been described in detail above, other modifications consistent with the spirit of this disclosure are contemplated.

What is claimed is:

1. A non-transitory computer program product storing instructions, which, when executed by at least one data processor, causes the at least one data processor to perform operations comprising:
sending an electronic message from a mail client, the electronic message including message content, including
facilitating determination of a first user's permission for content server access;
sending the message content to the content server for storage;
receiving a pointer at the mail client, the pointer configured to effect retrieval of the message content by a second user;
inserting the pointer into a header of the electronic message at the mail client; and
sending the electronic message with the header to the second user.

2. The computer program product of claim 1, further comprising:
receiving a sent electronic message, including
utilizing a sent pointer included in a sent header of the sent electronic message to retrieve a sent message content from a sender's content server;
facilitating determination of the recipient's permission for access to the sender's content server;
retrieving the sent message content; and
inserting the sent message content into the sent electronic message to be displayed to the recipient.

3. The computer program product of claim 1, further comprising configuring the mail client by registering an email address with the content server and receiving a password from the content server.

4. The computer program product of claim 1, wherein facilitating determination of the first user's permission for content server access includes providing to the content server a password assigned by the content server for comparing the password with the content server's database of registered user's passwords.

5. The computer program product of claim 2, further comprising:
providing the sender's content server with at least a password assigned to the recipient by the sender's content server in order to facilitate determination of the recipient's permission for access to the sender's content server.

6. The computer program product of claim 1, further comprising:
allowing the first user to make a selection at the mail client, wherein the selection includes whether or not the electronic message self-destructs after a defined period of time after the second user has viewed the message.

7. The computer program product of claim 1, further comprising:
allowing the first user to make a selection at the mail client, wherein the selection includes whether or not to encrypt the message content of the electronic message.

8. The computer program product of claim 1, further comprising:
selecting one or more of an attachment and a canned message to include in the electronic message and sending the attachment content to the content server for storage.

9. The computer program product of claim 8, further comprising:
sending a delete content request from the mail client to the content server for removing a successfully uploaded attachment content from the content server.

10. The computer program product of claim 8, further comprising:
including information in the pointer locating the attachment content stored in the content server of the one or more attachment.

11. The computer program product of claim 1, further comprising:
updating the message content stored on the content server by the first user, including
utilizing the pointer included in the header of the electronic message for sending a request to update the message content stored on the content server;
facilitating determination of the first user's permission for content server access;
updating the message content; and
storing the updated message content on the content server.

12. The computer program product of claim 1, further comprising:
screening incoming emails at the mail client for identifying which emails have been sent using the computer program; and
displaying the emails in a user's inbox with the emails assigned one or more visual indicators.

13. The computer program product of claim 12, wherein the visual indicators include one or more of a variety of colors, patterns, shapes or icons.

14. The computer program product of claim 12, wherein visual indicators are assigned to email in the user's inbox for visually identifying emails sent using the computer program, emails not sent using the computer program and counterfeit emails.

15. A method comprising:
sending an electronic message from a mail client, the electronic message including message content, including
facilitating determination of a first user's permission for content server access;
sending the message content to the content server for storage;
receiving a pointer at the mail client, the pointer configured to effect retrieval of the message content by a second user;
inserting the pointer into a header of the electronic message at the mail client; and
sending the electronic message with the header to the second user.

16. The method of claim 15, further comprising:
receiving a sent electronic message, including
utilizing a sent pointer included in a sent header of the sent electronic message to retrieve a sent message content from a sender's content server;
facilitating determination of the recipient's permission for access to the sender's content server;
retrieving the sent message content; and
inserting the sent message content into the sent electronic message to be displayed to the recipient.

17. The method of claim 15, further comprising configuring the mail client by registering an email address with the content server and receiving a password from the content server.

18. The method of claim 15, wherein facilitating determination of the first user's permission for content server access includes providing to the content server a password assigned by the content server for comparing the password with the content server's database of registered user's passwords.

19. The method of claim 16, further comprising:
providing the sender's content server with at least a password assigned to the recipient by the sender's content server in order to facilitate determination of the recipient's permission for access to the sender's content server.

20. The method of claim 15, further comprising:
allowing the first user to make a selection at the mail client, wherein the selection includes whether or not the electronic message self-destructs after a defined period of time after the second user has viewed the message.

21. The method of claim 15, further comprising:
allowing the first user to make a selection at the mail client, wherein the selection includes whether or not to encrypt the message content of the electronic message.

22. The method of claim 15, further comprising:
selecting one or more of an attachment and a canned message to include in the electronic message and sending the attachment content to the content server for storage.

23. The method of claim 22, further comprising:
sending a delete content request from the mail client to the content server for removing a successfully uploaded attachment content from the content server.

24. The method of claim 22, further comprising:
including information in the pointer locating the attachment content stored in the content server of the one or more attachment.

25. The method of claim 15, further comprising:
updating the message content stored on the content server by the first user, including
utilizing the pointer included in the header of the electronic message for sending a request to update the message content stored on the content server;
facilitating determination of the first user's permission for content server access;
updating the message content; and
storing the updated message content on the content server.

26. The method of claim 15, further comprising:
screening incoming emails at the mail client for identifying which emails have been sent using the computer program and
displaying the emails in a user's inbox with the emails assigned one or more visual indicators.

27. The method of claim 26, wherein the visual indicators include one or more of a variety of colors, patterns, shapes or icons.

28. The method of claim 26, wherein visual indicators are assigned to email in the user's inbox for visually identifying emails sent using the computer program, emails not sent using the computer program and counterfeit emails.
